(19) United States
(12) Patent Application Publication
(10) Pub. No.: US 2021/0069992 A1
(43) Pub. Date: Mar. 11, 2021

(54) PROCESS FOR THE PRODUCTION OF A METAL-PLASTIC-HYBRID COMPONENT AND METAL-PLASTIC-HYBRID COMPONENT

(71) Applicant: PROGRESS-WERK Oberkirch AG, Oberkirch (DE)

(72) Inventor: Lambert FEHER, Stutensee (DE)

(21) Appl. No.: 17/007,299

(22) Filed: Aug. 31, 2020

(30) Foreign Application Priority Data
Sep. 10, 2019 (DE) 10 2019 124 251.7

(51) Int. Cl. B29C 65/46; B29C 65/36; B29C 65/56

(52) U.S. Cl. CPC B29C 65/46; B29L 2023/22; B29C 65/565; B29C 65/3668

(57) ABSTRACT

A method for producing a metal-plastic-hybrid component comprises: providing a metal shaped piece, and providing a stiff plastics shaped piece made of a rigid thermoplastic. The geometry of the shape of the plastics shaped piece is at least partially adapted to that of the metal shaped piece. The method further comprises mechanically connecting the plastics shaped piece to the metal shaped piece in a manner such that the plastics shaped piece and the metal shaped piece are held against one another by intrinsic stress, and such that there is a substantial area of surface-contact between the plastics shaped piece and the metal shaped piece at at least one interface. The method further comprises inductively welding the plastics shaped piece to the metal shaped piece at the at least one interface.

### CROSS-REFERENCE TO RELATED APPLICATIONS

This application claims priority from German patent application No. 10 2019 124 251.7, filed on Sep. 10, 2019. The entire contents of this priority application are incorporated herein by reference.

### FIELD OF THE INVENTION

The invention relates to a method of producing a metal-plastic-hybrid component. The invention further relates to a metal-plastic-hybrid component.

### BACKGROUND

A metal-plastic-hybrid component of the present invention can in particular be used as a structural part of the bodywork of a vehicle. By way of example, this type of component can be a structural part of a cross-member, or can be the cross-member itself which bears the instrument panel and to which, by way of example, the steering column is mounted. However, a metal-plastic-hybrid component of the invention can also generally be any structural component of the bodywork of a vehicle.

Bodywork construction imposes two contrary requirements on the structural parts to be produced. On the one hand, the intention is to minimize the weight of these structural parts as much as possible, but on the other hand the structural parts must withstand mechanical stresses over long periods and have high stiffness and strength. Although structural parts manufactured in a conventional manner from steel with high wall thickness have high mechanical strength, they are disadvantageous because of their comparatively high weight. The weight problem is solved by using aluminium instead of steel, but the strength of aluminium is lower than that of steel.

A more recent approach to bodywork construction consists in the production of metal-plastic-hybrid components, i.e. components which combine the materials metal and plastic with one another. With these hybrid components it is possible both to save weight and to achieve adequate mechanical strength.

These hybrid components are produced in the prior art by overmoulding of steel inserts with polymeric materials, for example granulated polymers in liquid phase, or multicomponent liquid systems which undergo reactive polymerization, in injection-moulding machines. However, these production methodes are slow, and adhesion of the polymeric matrix on the steel inserts is also usually unsatisfactory. These conventional production methodes therefore place restrictions on the production rate and on the geometry of possible solutions; resultant costs of the individual hybrid components are high, as also is the cost of each individual design, realization and development.

### SUMMARY

It is an object of the invention to provide a method of producing a metal-plastic-hybrid component which can be carried out at a relatively high process velocity and which saves costs.

Another object of the invention is to provide a metal-plastic-hybrid component which can be produced at a low cost and in a simple manner.

According to an aspect invention, a method of producing a metal-plastic-hybrid component is provided comprising:

providing a metal shaped piece,

providing a stiff plastics shaped piece made of a rigid thermoplastic, wherein the geometry of the shape of the plastics shaped piece is at least partially adapted to that of the metal shaped piece,

mechanically connecting the plastics shaped piece to the metal shaped piece in a manner such that the plastics shaped piece and the metal shaped piece are held against one another by intrinsic stress, and such that there is a substantial area of surface-contact between the plastics shaped piece and the metal shaped piece at at least one interface, inductively welding the plastics shaped piece to the metal shaped piece at the at least one interface.

The method of the invention is not bound by the conventional concept of overmoulding of a metal insert for the production of a metal-plastic-hybrid component. In contrast, the method of the invention provides a plastics shaped piece that has already been prefabricated. The plastics shaped piece has been manufactured from a rigid thermoplastic, and has a high intrinsic stiffness and, respectively, dimensional stability. The following can, by way of example, be used as thermoplastic: polyamide (PA), polyetheretherketone (PEEK), polyvinyl chloride (PVC), polymethyl methacrylate (PMMA), polybutylene terephthalate (PBT), polycarbonate (PC), polypropylene (PP), acrylonitrile-butadiene-styrene (ABS) with copolymers etc., but it is also possible to use other rigid thermoplastics for the purposes of the invention. The thermoplastic can moreover be reinforced, for example glass-fibre reinforced or carbon-fibre reinforced. Thermoplastics are plastics which can be deformed within a certain elevated temperature range, where this procedure is reversible, e.g. can be repeated any desired number of times by cooling and reheating until the material is molten, as long as thermal decomposition of the material by overheating is avoided. In particular, thermoplastics can be welded.

A prefabricated plastics shaped piece and a prefabricated metal shaped piece, the latter preferably in the form of a shell, are provided in the method of the invention. In view of the required mechanical connection of the stiff plastics shaped piece to the metal shaped piece here, the geometry of the shape of the plastics shaped piece is at least partially adapted to that of the metal shaped piece (or vice-versa). The at least partial adaptation of the geometry of the shape of the plastics shaped piece to that of the metal shaped piece (or vice-versa) serves inter alia for subsequent good adhesion, arising through welding, of the two shaped pieces to one another.

Before the welding of the plastics shaped piece to the metal shaped piece, the two shaped pieces are connected mechanically to one another. The nature of the mechanical connection here is such that the plastics shaped piece and the metal shaped piece are held against one another by intrinsic stress, and specifically in a manner such that there is a substantial area of surface-contact between the plastics shaped piece and the metal shaped piece at at least one interface. Intimate contact between the plastics shaped piece and the metal shaped piece assists adhesion of the plastics shaped piece on the metal shaped piece as a result of the welding procedure. The nature of the intrinsic stress can be such that the plastics shaped piece is pressed against the metal shaped piece at the at least one interface, as is provided in a preferred embodiment of the invention.

The inductive welding of the plastics shaped piece to the metal shaped piece locally at the at least one interface can be carried out by means of a radiofrequency current with high current, in particular in a short time, for example in a few seconds or in about 1 second or less, preferably by a contactless process. A radiofrequency current with a frequency, by way of example, in the kHz range produces, in the metal shaped piece preferably in the form of a shell, eddy currents which, by way of resistive heat losses, very rapidly lead to three-dimensional heating, i.e. to instantaneous heating of the metal shaped piece to high temperature. The high temperature causes superficial or deeper melting of the plastics shaped piece in the region of the interface at which the plastics shaped piece is in contact with the metal shaped piece. The radiofrequency current is maintained only for a short time, and, because the plastics shaped piece is itself a poor heat conductor, the high temperature of the metal shaped piece causes superficial or deeper melting of the plastics shaped piece only in the immediate region of its area of contact with the metal shaped piece. The heating of the metal shaped piece to a high temperature causes expansion of the metal shaped piece in the region of the at least one interface with the plastics shaped piece, and the plastics shaped piece likewise expands in the region of the at least one interface with the metal shaped piece, the coefficient of thermal expansion of a thermoplastic typically being many times higher than the coefficient of thermal expansion of a metal such as steel or aluminium.

This reciprocal expansion of the plastics shaped piece in the region of its contact area and of the metal shaped piece in the region of its opposing contact area, in conjunction with the intimate contact of the contact area with the opposing contact area due to the mechanical connection with intrinsic stress, increases the pressure reciprocally exerted by the metal shaped piece preferably in the form of a shell and the plastics shaped piece, thus achieving particularly good adhesion of the plastics shaped piece on the metal shaped piece in the region of the at least one interface. After slow cooling of the resultant hybrid component (preferably without active cooling), the connection of the plastics shaped piece to the metal shaped piece then achieves its final strength.

The plastics shaped piece can be in contact with the metal shaped piece at a plurality of interfaces which are at various angles to one another and which lie in various parallel or non-parallel planes. The welding procedure thus achieves a connection with good adhesion in a plurality of dimensions.

The method of the invention can be carried out rapidly, with short cycle times and at low cost. The method of the invention is in particular suitable for mass production of hybrid components.

Preferred embodiments of the method are described below.

In a preferred embodiment, the metal shaped piece can be provided as a metal formed shell-shaped piece or as a tube. The metal shaped piece can also be composed of a plurality of shells. The geometry of the metal shaped piece can be as desired. In the case of a metal formed shell-shaped piece, this can have any desired cross section, for example the shape of a rectangular “C” or “L”. Longitudinal geometries of the metal shaped piece can likewise be as desired, and can include straight and curved shapes; this is also true in the case of tubes. A tubular metal shaped piece can also be composed of two or more half-shells assembled in the circumferential direction to give a tube, wherein this tube can have any desired cross-sectional shapes.

The plastics shaped piece is preferably provided as an injection moulding piece. The manner of manufacture of the plastics shaped piece is, as already described above, such that the geometry of its shape is at least partially adapted to the metal shaped piece and that it can be connected mechanically to the metal shaped piece with assistance from intrinsic stress or from pre-stressing.

It is preferable that the plastics shaped piece comprises a reinforcing structure.

This reinforcing structure can advantageously increase the mechanical strength or stability, in particular flexural stiffness, of the resultant metal-plastic-hybrid component. It is thus in particular possible to provide the metal shaped piece with a wall thickness that is smaller than the wall thickness of structural parts of about 1.5 mm usually encountered in bodywork construction. It is therefore possible in the method of the invention to provide the metal shaped piece with a wall thickness below 1 mm, while the plastics shaped piece contributes to the required mechanical stiffness of the hybrid component.

The abovementioned reinforcing structure can comprise cell walls, grids, and/or ribs. The reinforcing structure can be defined in advance during the course of designing the hybrid component to be produced such that the finished hybrid component has the desired mechanical stability properties.

The mechanical connection of the plastics shaped piece to the metal shaped piece can comprise insertion of the plastics shaped piece into a cavity of the metal shaped piece. The external shape of the plastics shaped piece here can be adapted at least in some regions to the internal shape of the metal shaped piece.

Such a cavity of the metal shaped piece can have at least one open peripheral side (for example in the case of a half-shell design of the metal shaped piece), or can have a closed periphery (in the case of a tubular metal shaped piece).

The insertion of the plastics shaped piece into the cavity of the metal shaped piece can cause the two shaped pieces to be held against one another mechanically as a result of intrinsic stress and to be pressed against one another over a substantial surface area at the at least one interface, in particular if the plastics shaped piece and/or the metal shaped piece is/are provided with pre-stress.

A plastics shaped piece inserted into the cavity of the metal shaped piece can, in the finished hybrid component, make a decisive contribution to the mechanical strength of the hybrid component, in particular flexural stiffness and torsional stiffness.

However, it is also possible, if permitted by the geometry of the metal shaped piece, that the mechanical connection of the plastics shaped piece to the metal shaped piece comprises placing the plastics shaped piece onto an outer side of the metal shaped piece. For this purpose, the plastics shaped piece can be adapted to achieve precise fit onto the shape of the outer side of the metal shaped piece.

In this case, the mechanical connection of the plastics shaped piece to the metal shaped piece again provides intimate contact between the regions of the plastics shaped piece and of the metal shaped piece that are subsequently to be welded to one another.

It is likewise possible that a plurality of plastics shaped pieces are connected to the metal shaped piece to obtain a hybrid component, wherein one or more plastics shaped pieces is/are placed onto an outer side of the metal shaped piece and/or one or more plastics shaped pieces is/are inserted into a cavity of the metal shaped piece.

In order to increase the intrinsic stress and thus the intrinsic pressure applied to the metal shaped piece by the plastics shaped piece in the region of the at least one interface, the plastics shaped piece and/or the metal shaped piece can comprise mechanically interlocking structures, wherein the mechanical connection of the plastics shaped piece to the metal shaped piece comprises mechanical locking of the metal shaped piece and of the plastics shaped piece to one another.

These mechanical interlocking mechanisms can firstly increase the intrinsic stress that holds the plastics shaped piece and the metal shaped piece against one another upon mechanical connection, and can likewise increase the pressure applied by the contact area against the opposing contact area; this additionally improves adhesion of the plastics shaped piece on the metal shaped piece after the welding procedure. These mechanical-interlocking structures can moreover also further improve the final strength of the hybrid component, and can provide even more reliable avoidance of undesired separation of the two shaped pieces. The mechanical connection of the two shaped pieces is moreover simplified, and the mechanical-locking structure(s) provide(s) clear definition of the location of the two shaped pieces relative to one another.

It is further preferable that the plastics shaped piece and/or the metal shaped piece is/are provided with mechanical pre-stress, in order to generate suitable intrinsic stress during the mechanical connection of the plastics shaped piece to the metal shaped piece.

If, by way of example, the metal shaped piece provided takes the form of a profile piece having, in cross section, a right-angled “C” shape, it is possible that one or both sides of the profile has/have a slight inclination towards the other, and that, when the plastics shaped piece is inserted into the cavity of the metal shaped piece, the two sides are then pushed slightly apart, the pre-stress thus resulting in clamping of the plastics shaped piece in the metal shaped piece. In the case of a placement of the plastics shaped piece onto an outer side of the metal shaped piece, it is possible in this example that the sides have a slight inclination away from one another, and that, when the plastics shaped piece is placed onto the metal shaped piece, the sides are then slightly pushed compressed, so that the plastics shaped piece clamps the metal shaped piece.

The inductive welding is preferably carried out by means of a coil to which a radiofrequency current is supplied.

The assembly made of metal shaped piece and plastics shaped piece can after mechanical connection thereof, by way of example and preferably be introduced in its entirety into the coil, or the coil can be passed over this assembly, thus permitting uniform application of the radiofrequency field to the assembly made of metal shaped piece and plastics shaped piece. As already mentioned above, for the welding procedure it is sufficient that current is supplied to the coil for a short time or in pulses, for example for a few seconds or about 1 second, with correspondingly high current intensity.

Advantageous criteria for the welding procedure are uniform treatment of the two shaped pieces after mechanical connection of same to one another, and therefore maximal uniformity and homogeneity of heating of the metal shaped piece.

For further improvement of adhesion of the metal shaped piece and plastics shaped piece to one another, the metal shaped piece and/or the plastics shaped piece can be provided with an adhesion promoter (primer layer) in the region of the at least one interface.

A primer layer can further improve the adhesion of the plastics shaped piece on the metal shaped piece during welding. A primer layer provided can, by way of example, take the form of a primer film, or else can be applied in the form of aerosol by spraying. The primer can have three layers or sublayers, where a first exterior layer in contact with the contact area of the plastics shaped piece exhibits particularly good adhesion on the plastics shaped piece, and the other external-side layer exhibits particularly good adhesion properties in relation to the metal of the metal shaped piece. The nature of a middle layer can be such that it has particularly good adhesion to both of the external layers. During welding, the primer is first immediately melted by way of the contact of the primer to the metal shell, and superficial melting of the intrinsically stressed and/or prestressed plastics shaped piece in the region of the at least one interface takes place subsequently because of thermal inertia. Metal sheets with a polymer coating are obtainable nowadays and can be metal-formed to produce metal shaped pieces.

As an alternative to, or in addition to, the primer, it is possible that the metal shaped piece has, in the region of the interface, surface structures such as pimples, teeth, ridges or macroscopic or microscopic surface-roughness features in order to improve adhesion of the plastics shaped piece on the metal shaped piece. These structures enlarge the area of adhesion between the shaped pieces, and the plastic melted during welding can surround these surface structures and/or penetrate into the same, thus improving adhesion of the plastic on the metal after cooling.

A hybrid component is moreover provided according to the invention, comprising a metal shaped piece, a rigid plastics shaped piece made of a thermoplastic, wherein the plastics shaped piece is at least partially adapted to a geometry of the metal shaped piece, wherein there is a substantial area of surface-contact between the plastics shaped piece and the metal shaped piece at at least one interface, and wherein the plastics shaped piece is welded to the metal shaped piece at the at least one interface.

The method of the invention has the advantages already mentioned above of capability for rapid, easy and inexpensive production. This hybrid component moreover features a large weight saving together with high mechanical strength.

The hybrid component has preferred embodiments which are stated in the claims and have advantages similar or identical to those already stated above with reference to the method of the invention.

The wall thickness of the metal shaped piece can moreover be less than 1.5 mm, in particular in a range of 0.5 mm to 1 mm. The metal shaped piece can moreover be made from steel, titanium or aluminium.

Further advantages and features will be apparent from the description below and from the drawings.

It is self-evident that the abovementioned features and features that remain to be explained below can be used not only in the respective combination stated but also in other combinations or individually without exceeding the scope of the invention.

### BRIEF DESCRIPTION OF THE DRAWINGS

Embodiments are shown in the drawings and are described in more detail below with reference to the said drawing, in which:

FIG. 1 shows a plan view of a metal shaped piece which can be used in a method of producing a metal-plastic-hybrid component;

FIG. 2 shows the metal shaped piece in FIG. 1 in a section along the line II-II in FIG. 1;

FIG. 3 shows a plan view of a plastics shaped piece for use with the metal shaped piece in FIGS. 1 and 2 in the method of producing the metal-plastic-hybrid component;

FIG. 4 shows the plastics shaped piece in FIG. 3 in a section along the line IV-IV in FIG. 3;

FIG. 5 shows the mechanically connected assembly made of plastics shaped piece in FIG. 3 or 4 and metal shaped piece in FIG. 1 or 2 in a section corresponding to FIG. 2 or 4, wherein the assembly is arranged in a coil in order to weld the plastics shaped piece to the metal shaped piece;

FIG. 6 shows a plan view of another plastics shaped piece for the production of a metal-plastic-hybrid component with the use of the metal shaped piece in FIGS. 1 and 2;

FIG. 7 shows the plastics shaped piece in FIG. 6 in a section along a line VII-VII in FIG. 6;

FIG. 8 shows the mechanically connected assembly made of plastics shaped piece in FIGS. 6 and 7 and metal shaped piece in FIGS. 1 and 2 in a section corresponding to FIG. 2 or 7, wherein the assembly is arranged in a coil in order to weld the plastics shaped piece to the metal shaped piece;

FIG. 9 shows a diagram illustrating the principle of pre-stressing of the metal shaped piece in a manner such that, during insertion of the plastics shaped piece into the metal shaped piece, the two shaped pieces are held against one another with assistance from intrinsic stress;

FIG. 10 shows a diagram similar to FIG. 9 illustrating the principle of prestressing of the metal shaped piece and the plastics shaped piece, wherein mechanical-locking structures are additionally configured on the plastics shaped piece and on the metal shaped piece;

FIG. 11 shows a diagram illustrating the principle of reciprocal thermal expansion of the plastics shaped piece and of the metal shaped piece during welding;

FIG. 12 shows another diagram similar to FIG. 11, illustrating the principle where a plastics shaped piece is respectively welded onto both sides of a metal shaped piece, where FIG. 12 again illustrates the thermal expansion of the metal shaped piece and of the two plastics shaped pieces;

FIG. 13 shows a perspective view of a practical embodiment of a metal shaped piece for the production of a metal-plastic-hybrid component;

FIG. 14 shows a perspective view of a practical embodiment of a plastics shaped piece for the production of a metal-plastic-hybrid component together with the metal shaped piece in FIG. 13;

FIG. 15 shows a perspective depiction of the mechanically connected assembly made of metal shaped piece and plastics shaped piece;

FIG. 16 shows another perspective depiction of the assembly made of plastics shaped piece and metal shaped piece;

FIG. 17 shows a perspective depiction showing the assembly made of plastics shaped piece and metal shaped piece in a radiofrequency coil for welding of the plastics shaped piece to the metal shaped piece;

FIG. 18 shows a perspective depiction of another metal-plastic-hybrid component;

FIG. 19 shows a perspective individual depiction of the plastics shaped piece of the metal-plastic-hybrid component in FIG. 18;

FIG. 20 shows a perspective plan view of another plastics shaped piece which can be used together with a tubular metal shaped piece to produce a metal-plastic-hybrid component;

FIG. 21 shows a perspective view of the plastics shaped piece in FIG. 20 from below; and

FIG. 22 shows a tubular metal shaped piece for the production of a metal-plastic-hybrid component with the use of one or more plastics shaped pieces according to FIGS. 20 and 21.

### PREFERRED EMBODIMENTS

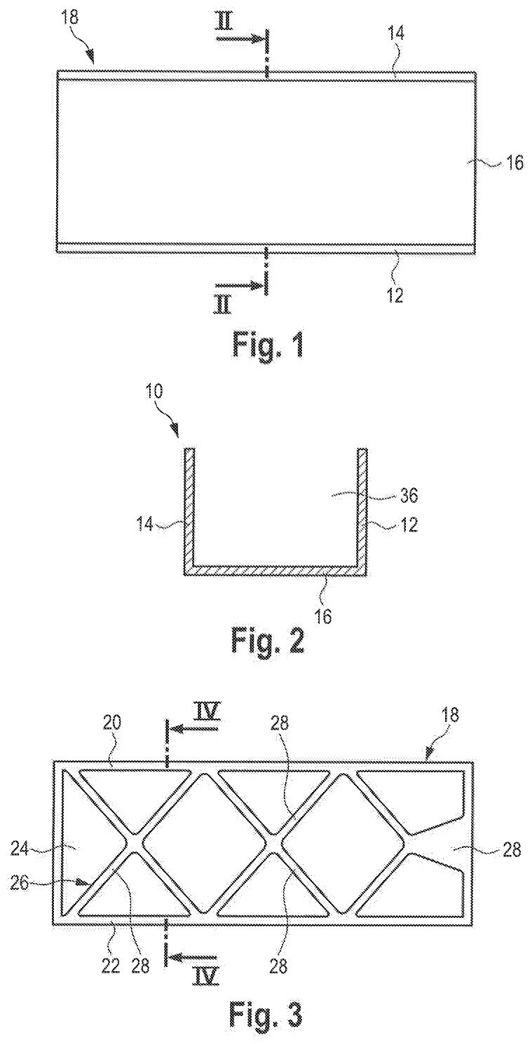

A general embodiment of a method of producing a metal-plastic-hybrid component is described with reference to FIGS. 1 to 5.

A shell-shaped metal shaped piece 10 shown in FIGS. 1 and 2 is provided in the method. The shell-shaped metal shaped piece can be a metal-formed piece made of a metal such as steel, titanium or aluminium, to mention only a few examples. In the embodiment according to FIGS. 1 to 5, the metal shaped piece is provided as a metal-formed piece. The shell-shaped metal-formed piece can have, in cross section, the shape of a “U” or “C” according to FIG. 2. The geometry of the metal shaped piece 10 can generally be as desired. In the embodiment shown, the metal shaped piece 10 has side walls 12 and 14, and also a bottom 16. The entire metal shaped piece 10 can be of single-piece or multiple-piece configuration.

A stiff or rigid plastics shaped piece 18, shown in FIGS. 3 and 4, is moreover provided. The plastics shaped piece 18 is made from a rigid thermoplastic and, at usual room temperature or usual ambient temperature, is stiff or rigid. The plastics shaped piece 18 can be produced in an injection-moulding method. The following can, by way of example, be used as thermoplastic: polyamide (PA), polyetheretherketone (PEEK), polyvinyl chloride (PVC), polymethyl methacrylate (PMMA), etc., but it is also possible to use other rigid thermoplastics for the purposes of the production of metal-plastic-hybrid components. The thermoplastic can be reinforced, for example carbon-fibre reinforced or glass-fibre reinforced, an example being PA GF 30, i.e. polyamide with 30% glass fibre content.

The plastics shaped piece 18 provided in the present embodiment is an injection moulding in the form of a shell. In cross section according to FIG. 4, the plastics shaped piece 18 is “U”-shaped or “C”-shaped, and has side walls 20, 22 and a bottom 24. The geometry of the shape of the plastics shaped piece 18 is adapted to the metal shaped piece 10. The plastics shaped piece 18 moreover comprises a reinforcing structure 26 made of cell walls 28. The reinforcing structure 26 can also comprise grids, ribs, struts and the like which are formed from the thermoplastic during injection moulding of the plastics shaped piece.

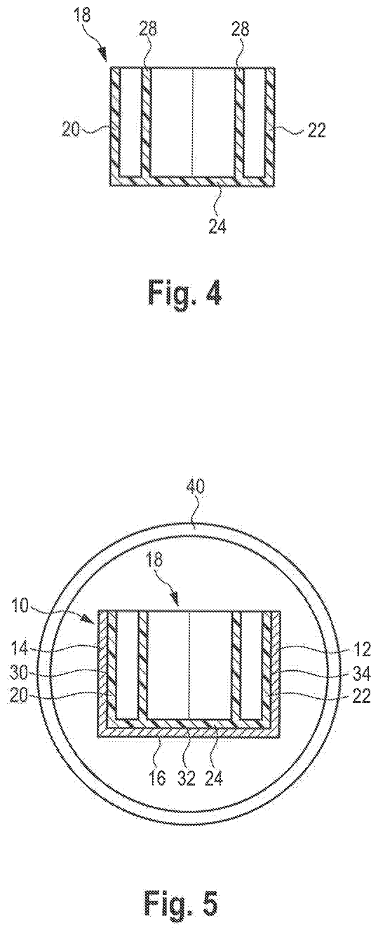

During the method of producing the metal-plastic-hybrid component, the shell-shaped metal shaped piece 10 and the plastics shaped piece 18 are first mechanically connected to one another, as shown in FIG. 5. The mechanical connection of the plastics shaped piece 18 to the metal shaped piece 10 is achieved in a manner such that the plastics shaped piece 18 and the metal shaped piece 10 are held against one another by intrinsic stress, and that there is a substantial area of surface-contact between the plastics shaped piece 18 and the metal shaped piece 10 at at least one interface where the two shaped pieces 10 and 18 adjoin one another. Interfaces 30, 32, 34 are present in the present embodiment.

The mechanical connection of the plastics shaped piece 18 to the shell-shaped metal shaped piece 10 can, as shown, be achieved via insertion of the plastics shaped piece 18 into a cavity 36 of the metal shaped piece 10 with precise fit. In accordance with the half-shell shape of the metal shaped piece 10, the cavity 36 has at least one open side.

The intrinsic stress can result from a slight overdimensioning of an exterior of the plastics shaped piece 18 in comparison with the internal dimension of the shell-shaped metal shaped piece 10 so that, when the plastics shaped piece 18 is inserted into the metal shaped piece 10 with precise fit, the side walls 12, 14 of the metal shaped piece 10 are slightly spread apart and, by virtue of the elasticity of the side walls, clamp the plastics shaped piece. By virtue of the intrinsic stress, the plastics shaped piece 18 and the shell-shaped metal shaped piece are pressed onto one another over a substantial area at the interfaces 30, 32, 34.

After the mechanical connection of the plastics shaped piece 18 to the metal shaped piece 10, the assembly is introduced into a radiofrequency coil 40, as shown in FIG. 5, in order to inductively weld the plastics shaped piece 18 to the metal shaped piece. As a result of supply of radiofrequency current, for example in the kHz range, to the radiofrequency coil 40 for a short period, the electromagnetic radiofrequency field produces instantaneous eddy currents in the metal shaped piece 10; these lead, via resistive heat loss, to heating of the metal shaped piece 10 to a high temperature. In the immediate region of the interfaces 30, 32, 34, the plastics shaped piece 18 consequently undergoes superficial melting or deeper melting and is welded to the metal shaped piece 10 at the interfaces 30, 32, 34. Because intrinsic stress provides mechanical connection of the plastics shaped piece 18 to the metal shaped piece 10, there is no requirement for additional pressure to apply the plastics shaped piece 18 to the metal shaped piece 10 during the inductive welding procedure.

Radiofrequency current can be supplied to the coil 40 for a short period, for example a few seconds, or about 1 second or even less. After switch-off of the radiofrequency current and cooling, the welded connection between the plastics shaped piece 18 and the shell-shaped metal shaped piece 10 then achieves its final strength.

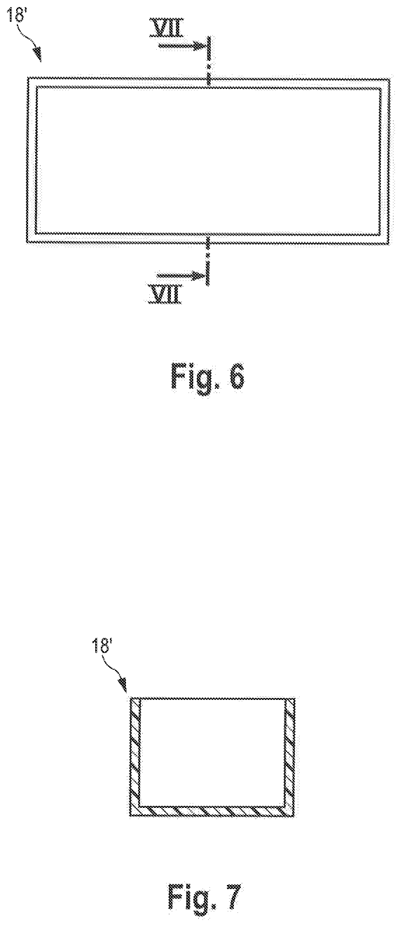

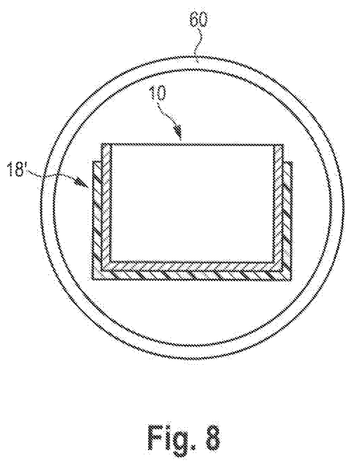

FIGS. 6 and 7 show a modified embodiment of a plastics shaped piece 18′ which, unlike the plastics shaped piece 18, is configured not as an insert part but instead as a part that can be placed onto an outer side of the metal shaped piece 10 (FIG. 2), as shown in FIG. 8. Again, in this case, it is possible to use prestressing of the plastics shaped piece 18′ and/or of the shell-shaped metal shaped piece 10 to allow mechanical connection of the two shaped pieces 10 and 18′ with assistance from intrinsic stress.

FIG. 8 shows the entirety of the mechanically connected assembly made of metal shaped piece 10 and plastics shaped piece 18′ in the coil 40 which is used to weld the plastics shaped piece 18′ to the metal shaped piece 10 via production of an electromagnetic radiofrequency field.

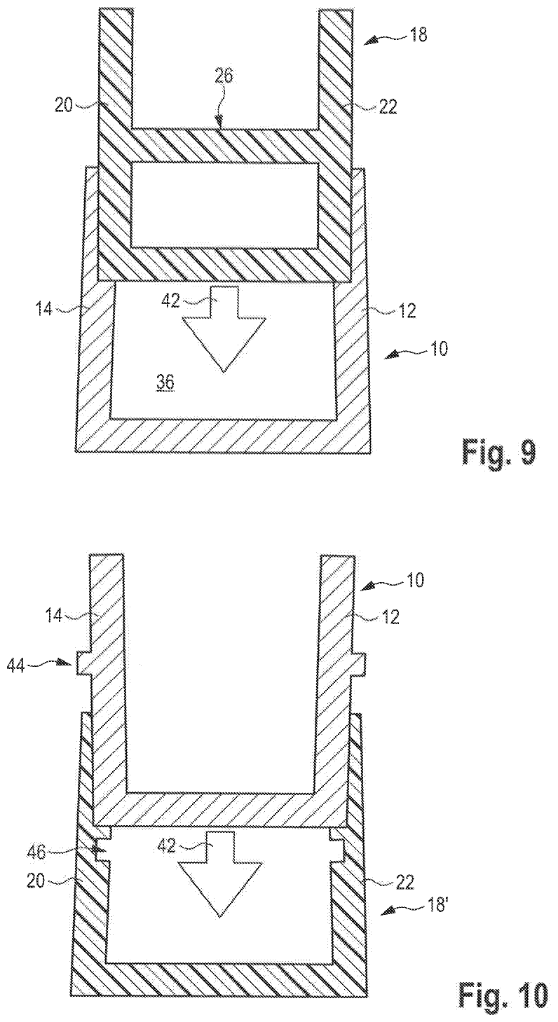

FIGS. 9 and 10 show diagrams of providing the plastics shaped piece 18 and/or of the shell-shaped metal shaped piece 10 with pre-stress which, during mechanical connection of the two shaped pieces to one another, holds the two shaped pieces 10, 18′ against one another mechanically with assistance from intrinsic stress.

FIG. 9 shows the case where the plastics shaped piece 18, optionally with reinforcing structure 26, is inserted into the shell-shaped metal shaped piece 10. In this case, the metal shaped piece 10 is provided with pre-stress, in that the side walls 12 and 14, or at least one of these, is/are inclined towards the other. During insertion of the plastics shaped piece into the cavity 36 of the metal shaped piece 10, the side walls 12, 14 of the shell-shaped metal shaped piece 10 are slightly spread apart elastically, and therefore, once the plastics shaped piece 18 has been inserted into the metal shaped piece 10, it is clamped in the metal shaped piece 10. An arrow 42 indicates the procedure of the insertion of the plastics shaped piece 18 into the metal shaped piece 10.

FIG. 10 shows the case where the plastics shaped piece 18′ is placed onto an outer side of the shell-shaped metal shaped piece 10. Prestressing can, by way of example, be achieved here in that the side walls 12, 14 of the metal shaped piece 10 are slightly inclined away from one another and/or in that the side walls 20, 22 of the plastics shaped piece 18′ are slightly inclined towards one another. Upon placement of the plastics shaped piece 18′ onto an outer side of the shell-shaped metal shaped piece 10, as again indicated by the arrow 42, the side walls 12, 14 are moved slightly towards one another elastically and/or the side walls 20, 22 of the plastics shaped piece 18′ are slightly spread apart elastically.

FIG. 10 moreover shows that there can be mechanical-locking structures 44, 46 on the plastics shaped piece 18′ and on the shell-shaped metal shaped piece 10; during mechanical connection of the metal shaped piece 10 to the plastics shaped piece 18′, the said structures provide mechanical locking of the two shaped pieces to one another. These mechanical-locking structures or surface structures, for example pimples, teeth, ridges, or macroscopic or microscopic surface-roughness features, in particular of the metal shaped piece 10 in the region of the interface or interfaces at which the plastics shaped piece 18 or 18′ is to be welded to the metal shaped piece 10 can further improve adhesion of the plastics material on the metal of the metal shaped piece 10.

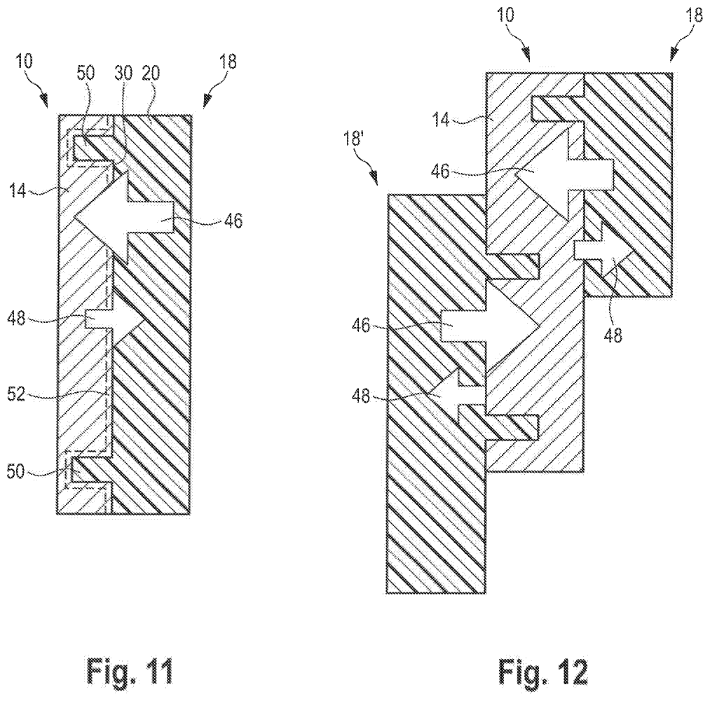

FIGS. 11 and 12 illustrate substance-bond/form-fit connection during inductive welding of the plastics shaped piece 18 to the metal shaped piece 10, where FIG. 11 shows a detail of the side wall 20 of the plastics shaped piece 18 and of the side wall 14 of the metal shaped piece 10. When the temperature of the metal shaped piece 10 increases in the radiofrequency field of the coil 40 (see FIG. 5), both the plastic of the plastics shaped piece 18 and the metal of the metal shaped piece 10 expand in the region of the interface 30. An arrow 46 indicates the thermal expansion of the plastic towards the metal shaped piece 10, and an arrow 48 indicates the thermal expansion of the metal of the metal shaped piece 10 towards the plastics shaped piece 18. The size of the arrows 46, 48 indicates that the thermal expansion of the thermoplastic material of the plastics shaped piece 18 is greater than the thermal expansion of the metal. The reciprocal thermal expansion of plastics shaped piece 18 and metal shaped piece 10 presses the two s 10, 18 against one another at the interface 30, i.e. the plastic 18 undergoes superficial or deeper melting, under pressure against the metal shaped piece 10.

Adhesion between the plastic of the plastics shaped piece 18 and the metal shaped piece 10 can be still further improved by, for example, providing a primer, i.e. an adhesion promoter, to the metal shaped piece 10 in the region of the interface 30. A primer layer 52 is indicated in FIG. 11. When the metal shaped piece 10 is provided, this primer can already be present thereon. By way of example, it is possible to obtain metal sheets coated with a thin polymer layer, where the polymer layer serves as a primer. The primer melts very quickly during heating of the shell-shaped metal shaped piece 10, and the plastic of the plastics shaped piece 18 also melts subsequently because of thermal inertia. The primer layer 52 promotes adhesion of the plastics shaped piece 18 on the metal shaped piece 10 at the interface 30.

FIG. 11 likewise shows surface structures 50, which here take the form of projections or pimples which engage in depressions in the shell-shaped metal shaped piece 10. These surface structures 50 can also serve as mechanical-locking structures, as described above.

At the interface 30, the metal shaped piece 10 can have microscopic or macroscopic surface-roughness features, or pimples, teeth, ridges, etc. with which the plastic of the plastics shaped piece 18 engages during melting or superficial melting.

FIG. 12 indicates that it is also possible to use inductive welding for secure connection of a plurality of plastics shaped pieces 18 and 18′ to a shell-shaped metal shaped piece, for example the metal shaped piece 10. It is therefore possible to weld, onto the metal shaped piece 10, of which only the side wall 14 is shown here, both a plastics shaped piece 18′ on the outer side and a plastics shaped piece 18 on the internal side, as has been described above.

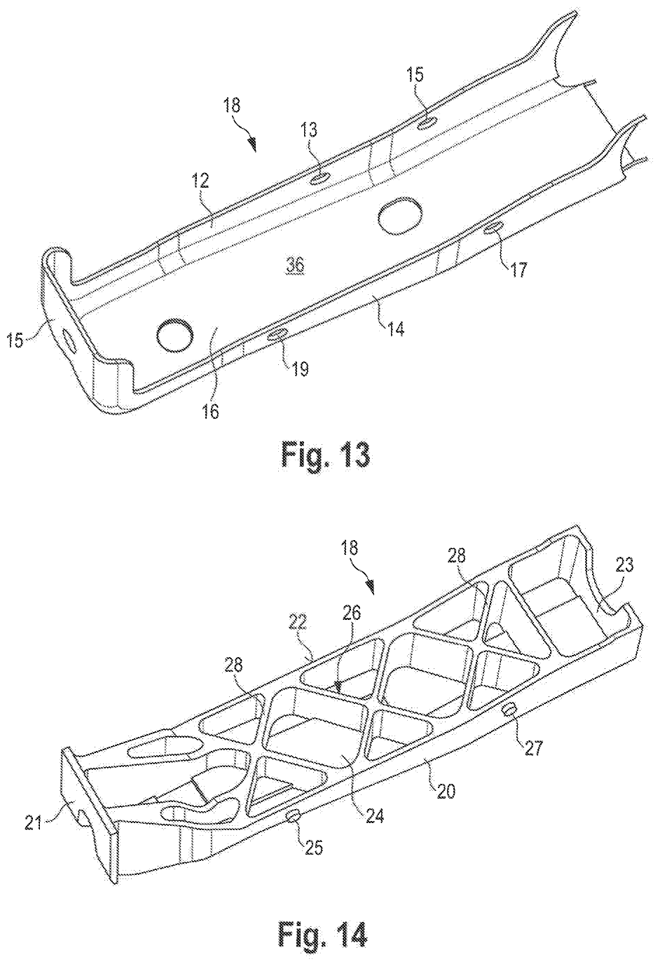

FIGS. 13 to 17 show a specific embodiment of a metal-plastic-hybrid component which can be produced by the method described herein.

For elements corresponding to elements in FIGS. 1 to 5, FIGS. 13 to 17 use the same reference signs as in FIGS. 1 to 5.

FIG. 13 shows the provision of the shell-shaped metal shaped piece 10. The shell-shaped metal shaped piece 10 has been manufactured, by way of example, from steel in a metal-forming procedure starting from a steel sheet. The metal shaped piece 10 is a half-shell, and has side walls 12, 14, 15, and also a bottom 16. There are, by way of example, apertures 17, 19 present in the bottom 16, and in the side walls 12 and 14 here there are apertures 13, 15, 17, 19 shown by way of example, which can serve as mechanical-locking structures for the mechanical connection to the plastics shaped piece 18. The metal shaped piece 10 has a cavity 36 which serves for the insertion of the plastics shaped piece 18. Internal sides of the side walls 12, 14 and 15, and also an internal side of the bottom 16, serve as interfaces for the subsequent welding of the plastics shaped piece onto the metal shaped piece 10.

FIG. 14 shows the plastics shaped piece 18 in isolation. The plastics shaped piece 18 has been adapted in respect of its external shape to the internal shape of the cavity 36 of the shell-shaped metal shaped piece 10. The plastics shaped piece 18 is per se stiff, and has been manufactured from a thermoplastic, as has been described above. The plastics shaped piece 18 has side walls 20, 22 and a bottom 24. Other side walls 21, 23 and also a reinforcing structure 26 with cell walls 28, contribute to the stiffness of the plastics shaped piece 18. The plastics shaped piece 18 has been manufactured as an injection moulding piece. Pimples 25, 27, and other pimples not visible on the external side of the opposite side wall 22, form mechanical-locking structures which engage with the apertures 19, 17 and, respectively, 13, 15 to provide mechanical locking during insertion of the plastics shaped piece 18 into the metal shaped piece 10.

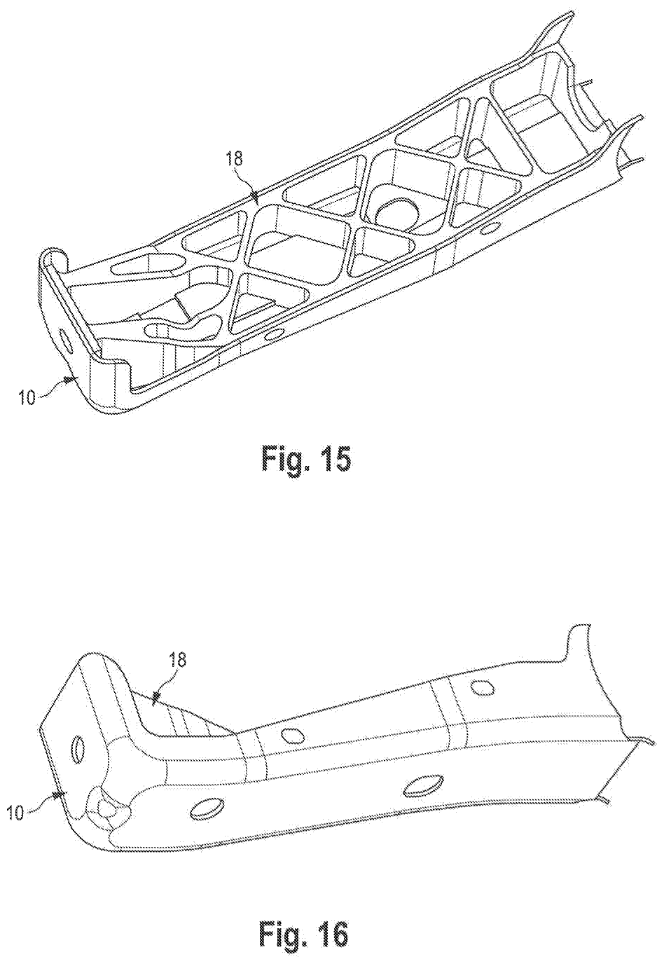

FIG. 15 shows the plastics shaped piece 18 and the metal shaped piece 10 after they have been mechanically connected to one another, the nature of the mechanical connection here again being such that the plastics shaped piece 18 and the metal shaped piece are held against one another with assistance from intrinsic stress, and that external areas of the side walls 20, 22, 21 have a substantial area of surface-contact with internal areas of the side walls 12, 14, 15 and are pressed against these. For this purpose, the geometry of the shape of the shell-shaped plastics shaped piece 18 can be adapted to the boundaries of the cavity 36 in the metal shaped piece 10, so that it is held by frictional forces, or clamped, in the metal shaped piece 10. FIG. 16 shows the entirety of the resultant mechanically connected assembly made of plastics shaped piece 18 and metal shaped piece 10 in a perspective view obliquely from below.

The outer faces of the side walls 20, 22 and 21 of the plastics shaped piece 18 and the internal areas of the side walls 12, 14 and 15 of the metal shaped piece 10 form the interfaces at which the two shaped pieces are to be welded to one another. Surface structures which improve adhesion (not shown) as described above can be present at the interfaces.

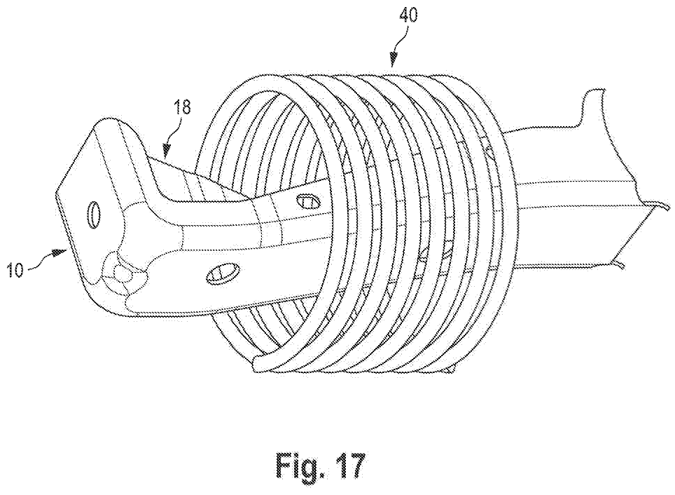

FIG. 17 shows the procedure of welding of the plastics shaped piece 18 to the metal shaped piece 10 by passing a coil 40 over the assembly made of the two shaped pieces 10, 18 or moving the assembly made of the shaped pieces 10, 18 into the coil 40. The coil 40 in FIG. 17 is shown with a length shorter than the length of the assembly made of the shaped pieces 10, 18, but it is self-evident here that the length of the coil 40 can also be the same as the length of the assembly of the shaped pieces 10, 18. If the length of the coil 40 is shorter, as shown in FIG. 17, the assembly made of the shaped pieces 10, 18 can be moved relative to the coil 40 during welding in order to reach all of the interfaces that are to be welded to one another of the shaped pieces 10, 18. After cooling the hybrid component is finished.

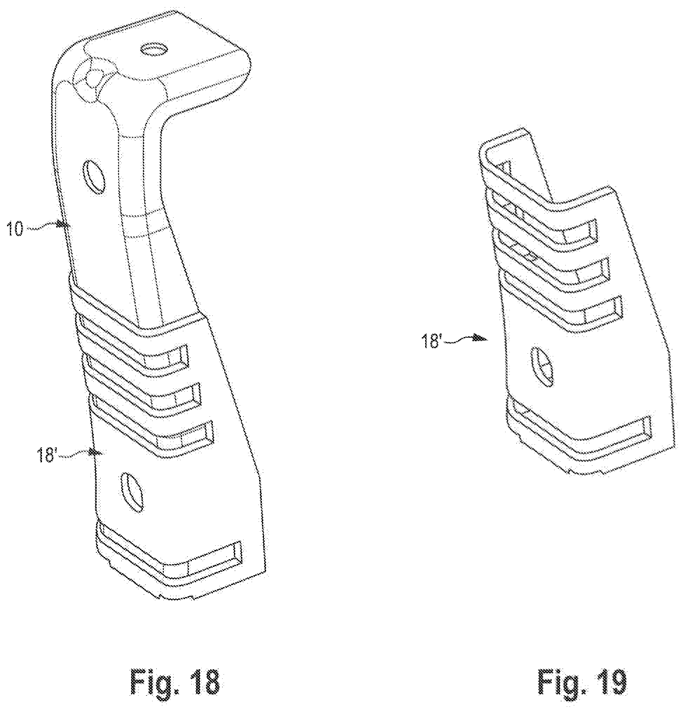

FIGS. 18 and 19 show a practical embodiment which corresponds to the embodiment in FIGS. 6 to 8. Here again, the reference signs used for comparable elements are the same as in FIGS. 6 to 8.

FIG. 18 shows a metal-plastic-hybrid component produced from the shell-shaped metal shaped piece 10 in FIG. 13 and a plastics shaped piece 18′ by inductive welding of the plastics shaped piece 18′ to the metal shaped piece 10. FIG. 19 shows the plastics shaped piece 18′ in isolation before joining to the metal shaped piece 10. In this embodiment, as in the above embodiment according to FIGS. 6 to 8, the plastics shaped piece 18′ has been placed onto an outer side of the metal shaped piece 10 and connected by inductive welding to the shell-shaped metal shaped piece 10, in substance-bonded, and respectively, form-fit manner. In other respects, reference is made to the description relating to FIGS. 6 to 8.

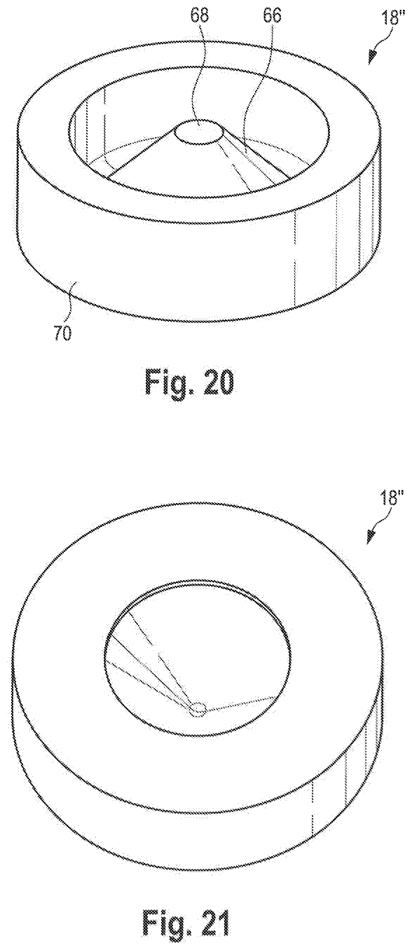

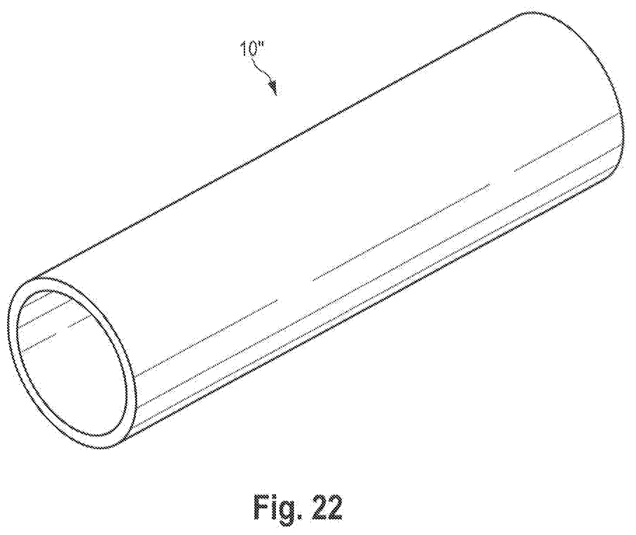

In the above embodiments, the metal shaped pieces 10 are configured as shell-shaped pieces. However, the method described herein can also be used for the production of metal-plastic-hybrid components where the metal shaped piece is tubular, and it is possible here to use not only straight tubes but also curved tubes as metal shaped pieces. FIG. 22 shows a metal shaped piece 10″ in the form of a straight tube. FIGS. 20 and 21 show a plastics shaped piece 18″ which can be used for the production of a metal-plastic-hybrid component with the use of a tubular metal shaped piece, for example the metal shaped piece 10″ in FIG. 22. FIG. 20 shows a perspective view of the plastics shaped piece 18″ from above, and FIG. 21 shows a perspective view of the plastics shaped piece 18″ from below. The cross section of the metal shaped piece 10″ can also be non-circular, rather than circular as shown, for example can be polygonal, for example rectangular, or elliptical or oval.

The plastics shaped piece 18″ is disc-shaped, and has a circular outer periphery adapted to the cavity of the tubular metal shaped piece. However, it is self-evident that the method described herein can also be used to produce metal-plastic-hybrid components which use tubular metal shaped pieces whose outer and/or inner shape can be non-circular, instead being polygonal, for example tetragonal.

The plastics shaped piece 18″ is configured as an insert for insertion into the cavity of the tubular metal shaped piece 10″.

The plastics shaped piece 18″ internally comprises a section 66 which narrows conically and forms a reinforcing structure. A plurality of the plastics shaped pieces 18″ are inserted in succession into the tubular metal shaped piece 10″, and specifically in a manner such that narrowed ends 68 of the sections 66 of two neighbouring plastics shaped pieces 18″ are mutually counterposed. At the narrowed ends 68 of the sections 66, there can be connecting structures for connecting the plastics shaped pieces 18″ to one another in pairs. An outer area 70 of the plastics shaped piece 18″ forms, with an internal area of the tubular metal shaped piece 10″, the interface at which the plastics shaped piece(s) 18″ is/are welded, with a substantial area of surface-contact, to the tubular metal shaped piece. When the plastics shaped piece(s) 18″ is/are inserted, mechanical connection of these to the tubular metal shaped piece is achieved as described above with assistance from intrinsic stress in a manner such that there is a substantial area of surface-contact between the plastics shaped piece 18″ and the metal shaped piece at the interface. Inductive welding is then used to weld the plastics shaped piece(s) 18″ internally to the tubular metal shaped piece.

The wall thickness of the metal shaped pieces 10 described herein, and also of the tubular metal shaped piece 10″, can be smaller than the usual wall thickness of 1.5 mm. The wall thickness of the metal shaped pieces can, by way of example, be in a range of 0.5 mm to 1 mm.

What is claimed is:

1. A method for producing a metal-plastic-hybrid component, the method comprising:
providing a metal shaped piece,
providing a stiff plastics shaped piece made of a rigid thermoplastic, wherein the geometry of the shape of the plastics shaped piece is at least partially adapted to that of the metal shaped piece,
mechanically connecting the plastics shaped piece to the metal shaped piece in a manner such that the plastics shaped piece and the metal shaped piece are held against one another by intrinsic stress, and such that there is a substantial area of surface-contact between the plastics shaped piece and the metal shaped piece at at least one interface,
inductively welding the plastics shaped piece to the metal shaped piece at the at least one interface.

2. The method according to claim 1, wherein the plastics shaped piece and the metal shaped piece are pressed against one another at the at least one interface by the intrinsic stress.

3. The method according to claim 1, wherein the metal shaped piece is provided as at least one of a metal formed shell-shaped piece, a metal formed piece composed of a plurality of shells, a tube.

4. The method according to claim 1, wherein the plastics shaped piece is provided as an injection moulding piece.

5. The method according to claim 1, wherein, in the region of the interface, the metal shaped piece has surface structures comprising at least one of pimples, teeth, ridges, macroscopic or microscopic surface-roughness features.

6. The method according to claim 1, wherein the plastics shaped piece comprises a reinforcing structure.

7. The method according to claim 6, wherein the reinforcing structure comprises at least one of cell walls, grids, ribs.

8. The method according to claim 1, wherein the metal shaped piece comprises a cavity, and the mechanically connecting of the plastics shaped piece to the metal shaped piece comprises inserting the plastics shaped piece into the cavity of the metal shaped piece.

9. The method according to claim 8, wherein the cavity of the metal shaped piece has at least one open peripheral side or a closed periphery.

10. The method according to claim 1, wherein the mechanically connecting of the plastics shaped piece to the metal shaped piece comprises placing the plastics shaped piece onto an outer side of the metal shaped piece.

11. The method according to claim 1, wherein at least one of the plastics shaped piece and the metal shaped piece comprises mechanical-locking structures, and the mechanically connecting of the plastics shaped piece to the metal shaped piece comprises mechanically locking the metal shaped piece and the plastics shaped piece to one another.

12. The method according to claim 1, wherein at least one of the plastics shaped piece and the metal shaped piece is provided with a mechanical pre-stress in order to generate the intrinsic stress when the plastics shaped piece is mechanically connected to the metal shaped piece.

13. The method according to claim 1, wherein the inductively welding is carried out using a coil to which radiofrequency current can be applied.

14. The method according to claim 1, wherein at least one of the metal shaped piece and the plastics shaped piece is provided with a primer layer at the at least one interface.

15. A hybrid component comprising
a metal shaped piece,
a rigid plastics shaped piece made of a thermoplastic, wherein
the plastics shaped piece is at least partially adapted to a geometry of the metal shaped piece,
there is a substantial area of surface-contact between the plastics shaped piece and the metal shaped piece at at least one interface of the metal shaped piece to the plastics shaped piece, and
the plastics shaped piece is welded to the metal shaped piece at the at least one interface.

16. The hybrid component according to claim 15, wherein the metal shaped piece has the form of a shell or of a tube.

17. The hybrid component according to claim 15, wherein the plastics shaped piece comprises a reinforcing structure.

18. The hybrid component according to claim 15, wherein the metal shaped piece comprises a cavity, and the plastics shaped piece is inserted into a cavity of the metal shaped piece, wherein said cavity has at least one open peripheral side or has a closed periphery.

19. The hybrid component according to claim 15, wherein the plastics shaped piece is arranged on an outer side of the metal shaped piece.

20. The hybrid component of claim 15, wherein at least one of the plastics shaped piece and the metal shaped piece has mechanical-locking structures.

21. The hybrid component according to claim 15, wherein the wall thickness of the metal shaped piece is less than 1.5 mm.

22. The hybrid component according to claim 15, wherein the wall thickness of the metal shaped piece is in a range of 0.5 mm to 1 mm.
